(19) United States
(12) Patent Application Publication
(10) Pub. No.: US 2013/0180664 A1
(43) Pub. Date: Jul. 18, 2013

(54) BONDING APPARATUS FOR LCD PANEL

(71) Applicants: Chiuan-Che Shiu, New Taipei City (TW); Rung-Shan Wang, Taoyuan County (TW); Kuo-Chang Teng, Taoyuan County (TW)

(72) Inventors: Chiuan-Che Shiu, New Taipei City (TW); Rung-Shan Wang, Taoyuan County (TW); Kuo-Chang Teng, Taoyuan County (TW)

(73) Assignee: CHUNGHWA PICTURE TUBES, LTD., Taoyuan (TW)

(21) Appl. No.: 13/454,093

(22) Filed: Apr. 24, 2012

(30) Foreign Application Priority Data
Jan. 18, 2012 (TW) 101102006

(51) Int. Cl. B32B 37/00

(52) U.S. Cl. 156/378

(57) ABSTRACT

A bonding apparatus for an LCD panel for bonding two plates together is provided. The bonding apparatus includes a base, a stage, a pressing head, a sensor and a control module. The two plates are disposed one on top of the other, and a gel is applied between the two plates. The pressing head is movably disposed on the base and above the stage. The sensor is disposed on the pressing head. The control module is electrically connected to the sensor and the pressing head. The control module drives the pressing head to move toward the stage such that the two plates are pressed between the pressing head and the stage. The sensor moves synchronously with the pressing head to contact an upper one of the two plates and senses a pressing distance of the pressing head relative to the two plates.

### CROSS-REFERENCE TO RELATED APPLICATION

This application claims the priority benefit of Taiwan application serial no. 101102006, filed on Jan. 18, 2012. The entirety of the above-mentioned patent application is hereby incorporated by reference herein and made a part of this specification.

### BACKGROUND OF THE INVENTION

1. Field of the Invention

The present invention relates to a bonding apparatus, and more particularly, to a bonding apparatus for a liquid crystal display (LCD) panel which is capable of directly sensing a distance of an object to be processed.

2. Description of Related Art

Following the rapid advance of technology and semiconductor industry, digital products such as personal digital assistant (PDA), mobile phone, smart phone and notebook computer (NB) have been more and more widely used in recent years. These digital products are being developed toward convenience in use, multi-function and aesthetic appearance to provide more chooses for the users. As the users have higher and higher demand on the digital products, the display, which plays an important role in the digital products, has become a focus for designers. Liquid crystal displays (LCD) have become the main stream of the displays.

An LCD mainly includes an LCD panel and a backlight module. In general, according to the display technology, if air enters the LCD panel in assembly of the LCD panel, the air tends to cause a reflection of external light which reduces the view ability of the LCD panel.

### SUMMARY OF THE INVENTION

Accordingly, the present invention is directed to a bonding apparatus for an LCD panel which is capable of directly sensing a distance of an object to be processed for facilitating the bonding operation.

One embodiment of the present invention provides a bonding apparatus for an LCD panel for bonding two plates together. The bonding apparatus includes a base, a stage, a pressing head, a sensor and a control module.

One of the two plates are disposed on top of the other, and a gel is applied between the two plates. The pressing head is movably disposed on the base and above the stage. The sensor is disposed on the pressing head. The control module is electrically connected to the sensor and the pressing head. The control module drives the pressing head to move toward the stage such that the two plates are pressed between the pressing head and the stage. The sensor moves synchronously with the pressing head to contact an upper one of the two plates and senses a pressing distance of the pressing head relative to the two plates.

In one embodiment, the bonding apparatus further includes a cover movably disposed on the base and above the stage. The cover is electrically connected to the control module so as to be driven by the control module to cover the base to form a sealed space. The stage and the two plates thereon are located within the sealed space. The pressing head and the sensor pass through the cover and are positioned above the two plates.

In one embodiment, the bonding apparatus further includes a vacuum module disposed on the base and in communication with the sealed space to form a vacuum state in the sealed space.

In one embodiment, the vacuum module is electrically connected to the control module, and the control module drives the pressing head to move toward the stage after driving the vacuum module to form the vacuum state in the sealed space.

In one embodiment, the gel is a light curing gel. The bonding apparatus further includes a light curing module disposed at one side of the stage. The light curing module includes a curing light source and an optical element. The curing light source emits light that is radiated to the light curing gel through the optical element.

In one embodiment, the curing light source passes through the cover and is positioned above the stage. When the cover covers the base, the curing light source moves with the cover to one side of the stage.

In one embodiment, the curing light source is disposed on the base and at one side of the stage.

In one embodiment, the optical element is a convex lens or a collimating lens.

In view of the foregoing, in the above embodiments of the present invention, the bonding apparatus for an LCD panel employs the pressing head, which is disposed on the base and above the stage, to press the two plates that are stacked on the stage. In addition, the sensor is disposed on the pressing head and can move synchronously with the pressing head to contact the upper plate to sense the pressing distance of the pressing head relative to the two plates. Therefore, the bonding apparatus can bond the two plates together and can directly sense a distance of the object to be processed to increase the control capability of the bonding apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates a bonding apparatus for an LCD panel according to one embodiment of the present invention.

FIG. 2 illustrates partial structures of a bonding apparatus according to another embodiment of the present invention.

### DESCRIPTION OF THE EMBODIMENTS

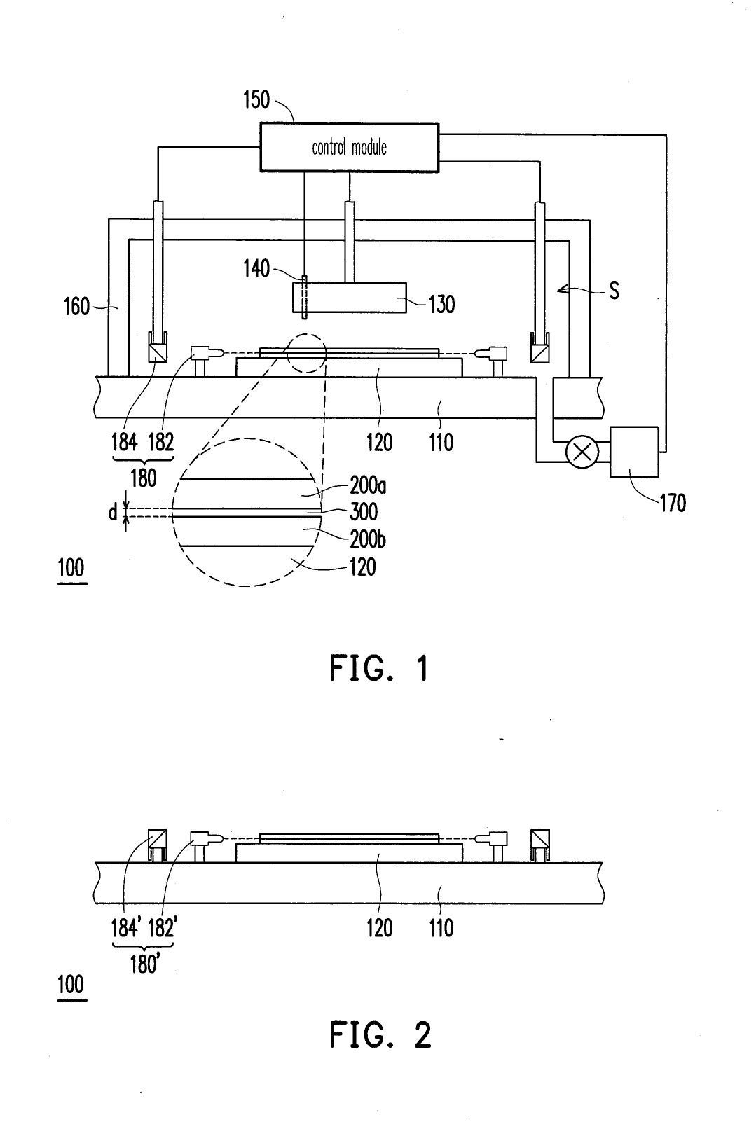

FIG. 1 illustrates a bonding apparatus for a liquid crystal display (LCD) panel according to one embodiment of the present invention. Referring to FIG. 1, in the present embodiment, the bonding apparatus 100 includes a base 110, a stage 120, a pressing head 130, a sensor 140, and a control module 150. The bonding apparatus 100 is used to bond two plates 200a, 200b together, for example, to bond two glass substrates of a LCD panel together. It is noted, however, the present invention is not intended to be limited to this particular application.

In particular, the two plates 200a, 200b need first to be disposed one on top of the other and are aligned by means of an optical sensing module (e.g. a CCD, not shown herein). After a gel 300 is applied onto the lower plate 200b, the upper plate 200a is stacked on the plate 200b. The stacked plates 200a, 200b are then disposed on the stage 120 for subsequent pressing and curing processes.

Further, in the bonding apparatus 100 of the present embodiment, the pressing head 130 is movably disposed on the base 110 and above the stage 120. The sensor 140 is disposed on the pressing head 130 to move with the pressing head 130. In the embodiment, the sensor 140 is embedded into the pressing head 130. A part of the sensor 140 is protruded from the pressing head 130 and faces toward the two plates 200a, 200b. The control module 150 is electrically connected to the sensor 140 and the pressing head 130, such that the pressing head 130 and the sensor 140 may be driven by the control module 150 to move toward and away from the stage 120.

In particular, the bonding apparatus 100 further includes a cover 160 movably disposed on the base 110 and above the stage 120. The cover 160 is electrically connected to the control module 150. After the plates 200a, 200b are stacked on the stage 120, the cover 160 is driven by the control module 150 to cover the base 110 to form a sealed space S. When the cover 160 covers the base 110 to form the sealed space S, the stage 120 and the two plates 200a, 200b disposed thereon are all located in the sealed space S, and the pressing head 130 and the sensor 140 pass through the cover 160 into the sealed space S and are positioned above the two plates 200a, 200b.

The control module 150 then drives the pressing head 130 and the sensor 140 to move synchronously from the position shown in FIG. 1 toward the stage 120, such that the pressing head 130 presses the two plates 200a, 200b against the stage 120. In the mean time, the sensor 140 also moves synchronously with the pressing head 130 to contact the upper plate 200a and senses a pressing distance d of the pressing head relative to the two plates 200a, 200b.

In particular, the thickness of the two plates 200a, 200b are known and, during the bonding operation, when the pressing head 130 presses the two plates 200a, 200b, the sensor 140 in contact with the upper plate 200a can simultaneously sense the pressing distance of the pressing head 130. Therefore, the control module 150 can obtain the thickness of the gel 300 which can be considered as the pressing distance d when the two plates 200a, 200b are pressed against each other.

The bonding apparatus 100 further includes a vacuum module 170, wherein the piping of the vacuum module 170 connects to the sealed space S through the base 110, such that the vacuum module 170 is in communication with the sealed space S for forming a vacuum state in the sealed space S. In one embodiment, the vacuum module 170 is disposed on the base 110 and at one side of the stage 120 with its piping inserted into the sealed space S through the base 110, as shown in FIG. 1. In addition, the connection between the vacuum module 170 and the sealed space S needs to be within a coverage of the cover 160 when the cover 160 covers the base 110, such that the vacuum module 170 is able to evacuate the sealed space S. Constructing the vacuum module 170 as above can avoid pipelines of the bonding apparatus 100 from moving with the cover 160 and therefore avoid pipeline wear due to such movement. In addition, it can also avoid the interferences of the vacuum module 170 to the moving cover 160 during the bonding operation performed by the bonding apparatus 100.

Further, the vacuum module 170 is electrically connected to the control module 150. Therefore, the control module 150 drives the vacuum module 170 to form a vacuum state in the sealed space S.

Referring to FIG. 1, after the sealed space S is formed, the control module 150 drives the vacuum module 170 to form a vacuum state in the sealed space S. During the course of forming the vacuum state in the sealed space S, the control module 150 drives the pressing head 130 to move toward the stage 120 to thereby press the two plates 200a, 200b. This causes bubbles in the gel 300 between the two plates 200a, 200b to be pumped out of the sealed space S due to the pressing and vacuum state of the sealed space S, thereby preventing the interior bubbles from affecting the utility of the bonded plates 200a, 200b.

On the other hand, in the present embodiment, the gel 300 is a light curing gel. Therefore, the bonding apparatus 100 further includes a light curing module 180. After the two plates 200a, 200b are pressed against each other, the bonding apparatus 100 may employ the light curing module 180 to perform the curing process.

In particular, referring to FIG. 1, the light curing module 180 includes an optical element 182 disposed on the base 110 and at one side of the stage 120. In addition, the light curing module 180 further includes a curing light source 184 that passes through the cover 160 and is positioned above the stage 120. When the cover 160 covers the base 110, the curing light source 184 moves with the cover 160 to one side of the stage 120, such that the optical element 182 is located between the curing light source 184 and the stage 120. As such, after the cover 160 covers the base 110, a predetermined degree of vacuum is reached in the sealed space 5, and the two plates 200a, 200b have been pressed against each other, the curing light source 184 emits light to the optical element 182 through which the light is radiated to the gel 300 between the two plates 200a, 200b, thus curing the gel 300 to secure the two plates 200a, 200b together.

FIG. 2 illustrates partial structures of a bonding apparatus according to another embodiment of the present invention. Referring to FIG. 2, in another embodiment of the present invention, the light curing module 180′ includes an optical element 182′ and a curing light source 184′, both of which are directly disposed on the base 110 and at one side of the stage 120, with the optical element 182′ positioned between the curing light source 184′ and the stage 120. As such, after the cover 160 covers the base 120 and the two plates 200a, 200b have been pressed against each other, the curing light source 184′ emits light to the optical element 182′ through which the light is radiated to the gel 300 between the two plates 200a, 200b, thus curing the gel 300 to secure the two plates 200a, 200b together. Thus, the two plates 200a, 200b can be bonded together by the gel 300.

In the above embodiments of the present invention, the optical element 182 or 182′ is, for example, a convex lens or a collimating lens that is used to successfully transmit the light emitted by the curing light source 184 or 184′ to the gel 300 between the plates 200a, 200b, without degrading the performance of curing the gel 300 due to diffusion and long distance transmission of the light. However, the present invention is not intended to limit the optical element 182 or 182′ to any particular form. Therefore, any optical element that can transmit the light emitted by the curing light source 184 or 184′ without attenuation to the gel 300 is applicable in the present invention.

In summary, in the above embodiments of the present invention, the bonding apparatus employs the pressing head, which is disposed on the base and above the stage, to press the two plates that are stacked on the stage. In addition, the sensor is directly disposed on the pressing head and can move synchronously with the pressing head to contact the upper plate to sense the pressing distance of the pressing head relative to the two plates. On the other hand, the cover can cover the base to form a sealed space, and the vacuum module can form a vacuum state in the sealed space to remove the bubbles in the gel. The light curing gel is applied between the two plates in advance, and the bonding apparatus includes the light curing module that can cure the gel to secure the two plates after the bonding apparatus finishes pressing the two plates. Therefore, the sensor is directly disposed on the pressing head and therefore can directly sense a distance of the object to be processed, such that the bonding apparatus has a higher control capability.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A bonding apparatus for a liquid crystal display panel for bonding two plates, the two plates disposed one on top of the other, a gel applied between the two plates, the bonding apparatus comprising:
a base;
a stage disposed on the base, and the two plates stacked on the stage;
a pressing head movably disposed on the base and above the stage;
a sensor disposed on the pressing head; and
a control module electrically connected to the sensor and the pressing head, the control module driving the pressing head to move toward the stage such that the two plates are pressed between the pressing head and the stage, the sensor moving synchronously with the pressing head to contact an upper one of the two plates and sensing a pressing distance of the pressing head relative to the two plates.

2. The bonding apparatus for a liquid crystal display panel according to claim 1, further comprising:
a cover movably disposed on the base and above the stage, wherein the cover is electrically connected to the control module so as to be driven by the control module to cover the base to form a sealed space, the stage and the two plates disposed thereon are located within the sealed space, and the pressing head and the sensor pass through the cover and are positioned above the two plates.

3. The bonding apparatus for a liquid crystal display panel according to claim 2, further comprising:
a vacuum module, wherein the piping of the vacuum module connects to the sealed space through the base, such that the vacuum module is in communication with the sealed space and the vacuum module is adapted to form a vacuum state in the sealed space.

4. The bonding apparatus for a liquid crystal display panel according to claim 3, wherein the vacuum module is electrically connected to the control module, and the control module drives the pressing head to move toward the stage after driving the vacuum module to form the vacuum state in the sealed space.

5. The bonding apparatus for a liquid crystal display panel according to claim 2, wherein the gel is a light curing gel, and the bonding apparatus further comprises:
a light curing module disposed at one side of the stage, the light curing module comprising a curing light source and an optical element, the curing light source emitting light that is radiated to the light curing gel through the optical element.

6. The bonding apparatus for a liquid crystal display panel according to claim 5, wherein the curing light source passes through the cover and is positioned above the stage, and when the cover covers the base, the curing light source moves with the cover to one side of the stage.

7. The bonding apparatus for a liquid crystal display panel according to claim 5, wherein the curing light source is disposed on the base and at one side of the stage.

8. The bonding apparatus for a liquid crystal display panel according to claim 5, wherein the optical element is a convex lens or a collimating lens.
